(19) United States
(12) Patent Application Publication
(10) Pub. No.: US 2023/0021337 A1
(43) Pub. Date: Jan. 26, 2023

(54) UTILITIES INFRATRUCTURE SELECTION

(71) Applicant: BRITISH TELECOMMUNICATIONS PUBLIC LIMITED COMPANY, London (GB)

(72) Inventors: Anthony Conway, London (GB); Carla Di Cairano-Gilfedder, London (GB); Alan Gould, London (GB)

(21) Appl. No.: 17/758,392

(22) PCT Filed: Dec. 18, 2020
(86) PCT No.: PCT/EP2020/087115

§ 371 Date: Jul. 5, 2022

(30) Foreign Application Priority Data
Jan. 5, 2020 (EP) 20150293.7

(51) Int. Cl. G06Q 50/08; G06Q 10/06; G06Q 10/04; G06N 5/02

(52) U.S. Cl. CPC G06Q 50/08; G06Q 10/06375; G06Q 10/0635; G06Q 10/04; G06N 5/022

(57) ABSTRACT

A method of defining a deployment specification for one or more infrastructure components as part of a transmission network for a utility service in a defined geographic region includes receiving a deployment specification for each of a plurality of deployment options, each received specification including a location and type of one or more infrastructure components for deployment in the region, each type of infrastructure component having associated infrastructure characteristics, and each location having associated location characteristics. The method further includes receiving environmental characteristics for the region; executing a classifier, for each deployment specification, based on one or more of the infrastructure characteristics, the location characteristics, and the environmental characteristics to forecast a measure of susceptibility of infrastructure deployed in accordance with the specification to one or more operational impediments of the infrastructure in use; and selecting a deployment specification based on the forecast susceptibilities.

### PRIORITY CLAIM

The present application is a National Phase entry of PCT Application No. PCT/EP2020/087115, filed Dec. 18, 2020, which claims priority from EP Patent Application No. 20150293.7 filed Jan. 5, 2020, each of which is hereby fully incorporated herein by reference.

### TECHNICAL FIELD

The present disclosure relates to the selection of infrastructure for a transmission network of a utilities service.

### BACKGROUND

Utility service providers have transmission networks for the transport, provision, communication or conveyance of a utility such as power (including electricity), gas (including natural gas), liquid (including water), sewage, and communications facilities (including fixed-line and/or mobile telephony and network connections such as broadband services). Transmission networks are comprised of network infrastructure including means and mechanisms for the transmission of the utility. Such infrastructure includes infrastructure components that can be categorized into component types. One categorization can include, for example, a nature of a location, installation or fitment of an infrastructure component such as: above-ground; under-ground; or affixed to another element such as a building or the like. Other or enhanced categorizations of infrastructure component types can include types according to a nature of a component such as a conduit, transmission wire, emitter or receiver or the like. Infrastructure components can include, for example, a duct, conduit, pipe, cable, pole, pylon, tower, and other transmission network infrastructure components as will be apparent to those skilled in the art.

Utility service providers are increasingly subject to infrastructure sharing obligations which require the provision of access to physical infrastructure such including infrastructure components to third parties. For example: ducts and poles can be shared; power can be shared; and infrastructure site access can be shared. These obligations on infrastructure owners introduces an additional requirement for effective infrastructure design, deployment and maintenance.

Accordingly, it is beneficial to provide improvements in the design, deployment and maintenance of utility transmission networks.

### SUMMARY

According to a first aspect of the present disclosure, there is provided a computer implemented method of defining a deployment specification for one or more infrastructure components as part of a transmission network for a utility service in a defined geographic region, the method comprising: receiving a deployment specification for each of a plurality of deployment options, each received specification including a location and type of one or more infrastructure components for deployment in the region, each type of infrastructure component having associated infrastructure characteristics identifying features of the infrastructure component, and each location having associated location characteristics identifying features of the location; receiving environmental characteristics for the region identifying environmental features of the region; for each deployment specification, executing a classifier to forecast a measure of susceptibility of infrastructure deployed in accordance with the specification to one or more operational impediments of the infrastructure in use, the classifier being executed based on each of one or more of the infrastructure characteristics, the location characteristics and the environmental characteristics; selecting a deployment specification based on the forecast susceptibilities to trigger deployment of infrastructure components in accordance with the selected deployment specification.

In some embodiments, the classifier is trained based on training data items each relating to one or more deployed infrastructure components in respect of which the training data item includes infrastructure characteristics, location characteristics, environmental characteristics, and an indication of one or more operational impediments affecting the deployed infrastructure components.

In some embodiments, an operational impediment of infrastructure is an impediment to the operation of, access to or maintenance of the infrastructure in use.

In some embodiments, an infrastructure component includes one or more of: a duct; a conduit; a pipe; a cable; a pole; a pylon; and a tower.

In some embodiments, operational impediments include one or more of: erosion; corrosion; rotting; movement; damage; being struck; fracture; perforation; blockage; clogging; collapse; silting; and pest damage.

In some embodiments, features of an infrastructure component include one or more of: a type of component including one or more of a duct, a conduit, a pipe, a cable, a pole, a pylon, and a tower; one or more materials of manufacture of the component; one or more configurations of the component; a deployment feature of the component such as being laid or hung; and one or more physical characteristics of the component including one or more of: a mass; density; porosity; permeability; cross-sectional shape; rigidity; strength such as tensile or compressive strength; corrosion resistance; flexibility; brittleness; durability; elasticity; resilience; and thermal properties.

In some embodiments, features of a location include one or more of: a topography of the location including one or more of: an elevation, altitude, slope, and incline; a longitude and/or latitude of the location; a relative or absolute water table level for the location; water flow information for the location; an identification of one or more faults, fissures, shafts and/or voids in the ground at the location; a type of soil at the location; an identification of one or more mineral or resource deposits at the location; a history of the location including one or more of: prior development at the location; and prior uses of the location; soil salinity; airborne salinity; geographic features at or proximate to the location including natural, landform and/or artificial features; an identification of vegetation at or proximate to the location; an identification of streams, rivers, seas, oceans or deltas at or proximate to the location; an identification of hills, mountains and plains at or proximate to the location; an identification of one or more pre-existing infrastructure components at or proximate to the location including: ducts; conduits; pipes; cables; poles; pylons; and towers; and an identification of buildings at or proximate to the location.

In some embodiments, environmental features include one or more of: climatic features including one or more of a statistical measure of: temperature, humidity, pressure, wind, and precipitation; and weather features including one or more of frequency and severity of one or more of: flooding; storm; excessive wind speed; drought; cold event; snow; and ice.

In some embodiments, selecting a deployment specification based on the forecast susceptibilities includes ranking each deployment specification based on one or more metrics derived from the forecasting by the classifier for the deployment specification.

In some embodiments, a metric is evaluated for each deployment specification based on a combination of each forecast measure of susceptibility for each of one or more impediments for the deployment specification.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement to define a deployment specification for one or more infrastructure components as part of a transmission network for a utility service in accordance with an embodiment of the present disclosure.

FIG. 3 is a flowchart of a method for defining a deployment specification for one or more infrastructure components as part of a transmission network for a utility service in accordance with an embodiment of the present disclosure.

FIG. 4 is a component diagram of an arrangement to define a deployment specification for one or more infrastructure components as part of a transmission network for a utility service in accordance with an embodiment of the present disclosure.

FIG. 5 is a flowchart of a method for defining a deployment specification for one or more infrastructure components as part of a transmission network for a utility service in accordance with an embodiment of the present disclosure.

FIG. 6 is a component diagram of an arrangement to define infrastructure components as part of a transmission network for a utility service in accordance with an embodiment of the present disclosure.

FIG. 7 is a flowchart of a method for maintaining infrastructure components as part of a transmission network for a utility service in accordance with an embodiment of the present disclosure.

### DETAILED DESCRIPTION

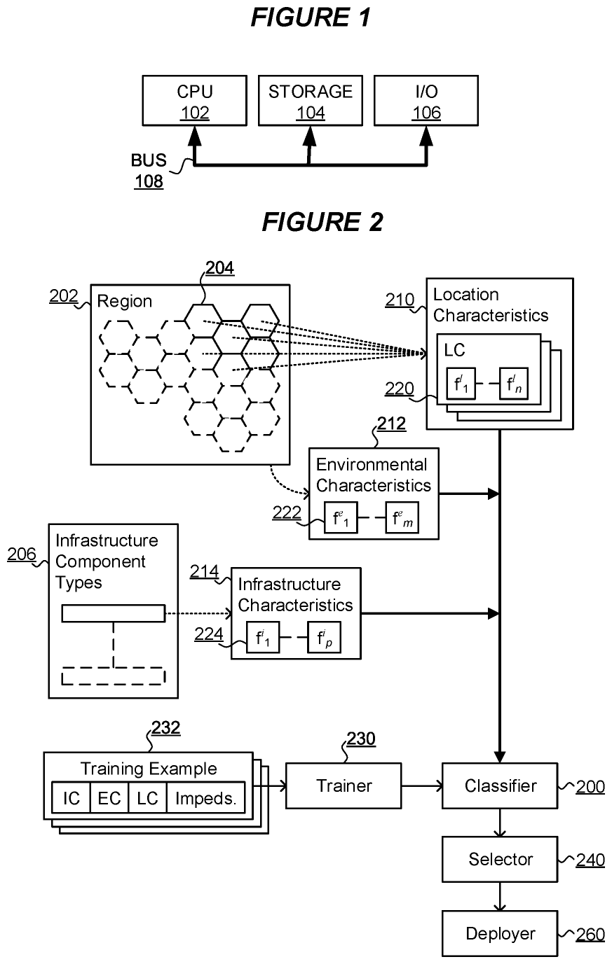

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement to define a deployment specification for one or more infrastructure components as part of a transmission network for a utility service in accordance with an embodiment of the present disclosure. In the arrangement of FIG. 2, a utility service has a requirement to provide transmission network infrastructure within a defined geographic region 202. The region 202 has associated environmental characteristics 212 (EC) as a set of one or more environmental features 222 f^{e}₁ to f^{e}ₘ. The environmental characteristics 212 are applicable to the entire region and the environmental features can include one or more of, for example, inter alia: climatic features including one or more of a statistical measure of: temperature; humidity; pressure; wind; and precipitation; and weather features including one or more of frequency and severity of one or more of: flooding; storm; excessive wind speed; drought; cold event; snow; and ice. For example, in one embodiment, environmental characteristics 212 for the region 202 includes features of: an average temperature; an average precipitation; a minimum and maximum humidity; a frequency of flooding; and a measure of an extent of flooding (such as a proportion of the region flooded, a relative water level above an average water level, or other suitable measure).

The region 202 includes a plurality of locations 204 which can be defined as regularly shaped and/or sized, irregularly shaped and/or sized, adjacent, spaced or any suitable combination of these according to a suitable location definition. For example, the region 202 can be subdivided into portions each constituting locations suitable for the deployment of infrastructure for a transmission network. Suitability can be determined, for example, based on suitability criteria considering factors such as natural geographic features such as landforms; and/or artificial geographic features such as areas of settlements and engineered constructs. Thus, the subdivision of a region into locations can include the exclusion of portions of the region 202 as inherently unsuitable for infrastructure deployment based on, for example, predetermined suitability criteria.

Each location 204 of the region 202 has associated location characteristics 220 (LC) which can be collectively provided in a repository of location characteristics 210 for all locations in the region 202 such as a database or other suitable data structure. Location characteristics 220 for a location 204 include a set of one or more features f^{l}₁ to f¹ₙ of the location 204. For example, features of the location 204 can include one or more of, inter alia: a topography of the location including one or more of: an elevation; altitude; slope; and incline; a longitude and/or latitude of the location; a relative or absolute water table level for the location; water flow information for the location; an identification of one or more faults, fissures, shafts and/or voids in the ground at the location; a type of soil at the location; an identification of one or more mineral or resource deposits at the location; a history of the location including one or more of: prior development at the location; and prior uses of the location; soil salinity; airborne salinity; geographic features at or proximate to the location including natural, landform and/or artificial features; an identification of vegetation at or proximate to the location; an identification of streams, rivers, seas, oceans or deltas at or proximate to the location; an identification of hills, mountains and plains at or proximate to the location; an identification of one or more pre-existing infrastructure components at or proximate to the location including: ducts; conduits; pipes; cables; poles; pylons; and towers; and/or an identification of buildings at or proximate to the location.

A deployed infrastructure network or portion thereof within the region 204 is comprised of infrastructure components that can be categorized into one or more component types 206 as previously described. Notably, in some embodiments each infrastructure component can correspond directly to a single component type 206 such that a component type and infrastructure component are synonymous. In other embodiments, a component type is a class of multiple infrastructure components. For example, a pipe for the transmission of liquid such as water in a utility network can be categorized according to its material of manufacture such that plastic pipes belong to a first infrastructure component type 206 while clay pipes belong to a second component type 206. Further and alternative classifications of infrastructure components can also be provided.

Each infrastructure component type 206 has associated infrastructure characteristics 214 (IC) identifying features of infrastructure components belonging to the component type 206. Features of an infrastructure component can include, for example, inter alia: a type of component including one or more of a duct, a conduit, a pipe, a cable, a pole, a pylon, and a tower; one or more materials of manufacture of the component; one or more configurations of the component; a deployment feature of the component such as being laid or hung; and/or one or more physical characteristics of the component including one or more of: a mass; density; porosity; permeability; cross-sectional shape; rigidity; strength such as tensile or compressive strength; corrosion resistance; flexibility; brittleness; durability; elasticity; resilience; and thermal properties.

The arrangement of FIG. 2 includes a classifier 200 as a machine learning component suitable for generating a classification as an output based on an input set of parameters. For example, the classifier 200 is implemented as a neural network or support vector machine, though other suitable classifiers are and may become available. The classifier is configured to accept, as an input data set, a data structure corresponding to one or more of: location characteristics 220; environmental characteristics 212; and infrastructure characteristics 214 for a particular infrastructure component in a particular location 204 within the region 202. In one embodiment, the input data set of the classifier 200 includes each of the location characteristics 220; the environmental characteristics 212; and infrastructure characteristics 214.

The classifier 200 is trained to generate an output classification indicative of a susceptibility of an infrastructure component in use, when deployed to the particular location 204 in the region 202, to one or more operational impediments. Operational impediments can include, for example, impediments to the operation of, access to or maintenance of the deployed infrastructure component, i.e. when such infrastructure component is in use as part of a utility transmission network at the particular location 204 in the region 202. For example, in one embodiment, operational impediments include one or more of, inter alia: erosion; corrosion; rotting; movement; damage; being struck (such as by a vehicle); fracture; perforation; blockage; clogging; collapse; silting; and damage by pests.

In one embodiment, the classifier 200 is trained by a trainer 230 component as a hardware, software, firmware or combination component arranged to provide classifier training functionality based on training data 232 provided as a plurality of training examples. For example, the classifier can be provided as a feedforward neural network trained using a supervised back-propagation algorithm. Accordingly, each training example includes both an input data set for an example deployed infrastructure component and a classification for that example deployed infrastructure based on observed, experienced or otherwise known operational impediments exhibited by, experienced at or arising with the example deployed infrastructure component. Thus, in the exemplary embodiment, each training example includes location characteristics 220 (LC); environmental characteristics 212 (EC); and infrastructure characteristics 214 (IC) for the example deployed infrastructure component, along with an indication of the impediments (Impeds.) for that component.

In one embodiment, the input data set for the classifier is arranged using a one-hot vector or matrix encoding of data items such that, for example, each feature fⁱ₁ to fⁱₚ of infrastructure characteristics for an infrastructure component are enumerated into a set of possibilities, each possibility being encoded within a vector by correspondence to a particular vector position or offset such that a vector input for all characteristics in the classifier input data set can be provided to the classifier 200 for processing thereby. Similarly, in one embodiment, the classifier 200 can indicate output classifications by one-hot vector or matrix encoding such as, for example, enumerating all operational impairments for encoding within an output vector by each impairment corresponding to a particular output vector position or offset. Additionally or alternatively, an adaptation on the one-hot technique can be employed according to which each element in an encoded vector has a numeric quantity indicating a degree of association with that element such that, for example, a degree of association with a class indicating an operational impediment is indicated by a value encoded within an applicable element within the output vector for that impediment. For example, the degree of association can be a normalized degree in a range of, for example, 0 to 1. In this way, relative degrees of classification can be determined by the classifier. Such an arrangement requires that training examples indicate operational impediments by degree of association so that the classifier 200 can be effectively trained.

Thus, in use, the trained classifier 200 is used to classify locations 204 in the region 202 based on each of one or more infrastructure component types 206 for each location to forecast a measure of susceptibility of each component type 206 in each location 204 to one or more operational impediments. For example, the operation of the classifier can be used to determine susceptibility measures for multiple or all locations in the region 202, each for one or more infrastructure component types 206. The susceptibility measures are subsequently processed by a selector 240 as a hardware, software, firmware or combination component arranged to select one or more locations 204 based on the determined susceptibility measures. In one embodiment, the selector 240 is further adapted to select one or more infrastructure component types 206 based on the determined susceptibility measures. For example, the selection of one or more locations in the region 202 can be based on a ranking process in which each location is ranked based on metrics derived from the forecasting by the classifier 200. Such metrics can be determined based on a combination of a classification or a degree or extent of classification for each of one or more impediments for each location, such as a count of impediments, or a summation or average degree of membership with one or more impediments in the classification. More sophisticated methods of measuring, summarizing, combining or otherwise representing classified impediments for a location can be employed to provide a basis for comparison between locations. For example, certain impediments can be emphasized or de-emphasized depending on operational considerations, with weighted factors being applied accordingly to a measure of a degree of membership with a class representing an impediment in the classifier output for a location.

In one embodiment, a representation of the region 202 is provided such as a map, plan or specification of the region by way of a data structure, image or other suitable storage and representation means. In this embodiment, the selector is operable to annotate, markup or otherwise adjust the representation of the region 202 so as to indicate, for each of at least a subset of the locations 204 in the region, classifications of those locations in the region representation. Such representation can be by way of the inclusion of metadata or renderable data content in, with or in association with the representation of the region 202. Notably, where such enhanced representation of the region 202 is provided in a manner suitable for processing—such as a data structure, matrix, bitmapped or image representation of the region 202, the enhanced representation of the region 202 can constitute an input to an infrastructure design facility such as a software component arranged to specify a suitable arrangement of infrastructure components for deployment. Such a design facility can identify, for example, a set of one or more locations and, optionally, infrastructure component types, for the deployment of infrastructure to meet a need of the utility service transmission network.

In one embodiment, one or more predetermined locations in the region 202 can be predetermined as location to, through or adjacent to which transmission infrastructure is required. For example, start, end, entry or exit locations in the region for a portion of transmission network can be predetermined. In such embodiment, the selection of locations 204 by the selector 240 can be further based on such predetermined locations such that locations are selected for the deployment of infrastructure components in order to satisfy any requirement in relation to such predetermined locations. For example, where a transmission network is required to traverse the region 202 from an entry location to the region (corresponding to a location adjacent an exit location in an adjoining region) to an exit location in the region (corresponding to a location adjacent an entry location in an adjoining region), such predetermined entry and exit locations can be prerequisite locations on which basis other locations are selected so as to, for example, provide a route through the region from the entry location to the exit location through intermediate locations, the measure of susceptibility of each of intermediate locations being determined to be acceptable or most suitable in the context of all suitable locations in the region 202.

The acceptability of one or more locations for the deployment of infrastructure can be determined based on one or more rules, criteria or functions. For example, criteria can relate to a number, frequency or extent of susceptibility of infrastructure to impediments. Alternatively or additionally, relative minima or maxima degrees or extents of susceptibility within the region may be required. Further additionally or alternatively, optimization functions such as hill-climbing or other optimization techniques can be employed based on the measured susceptibility of each location to select locations within the region 202.

A deployer 260 is provided as a hardware, software, firmware or combination component for triggering a deployment of the one or more infrastructure components selected by the selector 240. Such deployment can be effected by way of automated deployment techniques where transmission network infrastructure components can be so deployed automatically, or alternatively by the provision of a deployment specification identifying selected locations and, optionally, infrastructure component types. Such deployment specification can be used to trigger a deployment of new infrastructure components.

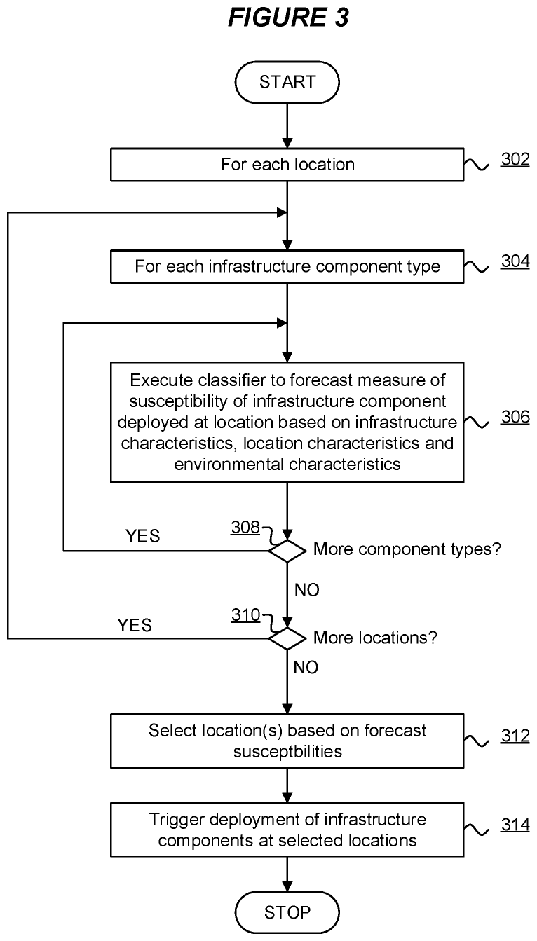

FIG. 3 is a flowchart of a method for defining a deployment specification for one or more infrastructure components as part of a transmission network for a utility service in accordance with an embodiment of the present disclosure. Initially, at 302, the method loops through each location 204 in the region 202. At 304 the method loops through each of one or more infrastructure component types 206. For a current location and component type, the method executes the classifier 200 at 306 to forecast a measure of susceptibility of infrastructure deployed at the current location to one or more operational impediments of the infrastructure in use. The classifier 200 is executed based on each of one or more of the infrastructure characteristics for the current infrastructure component type, the location characteristics for the current location and the environmental characteristics. At 308 the method continues the loop through component types, and at 310 the method continues the loop through locations. Subsequently, at 312, the method selects one or more locations in the region 202 based on the forecast susceptibilities. At 314 the method triggers deployment of infrastructure components at the selected locations.

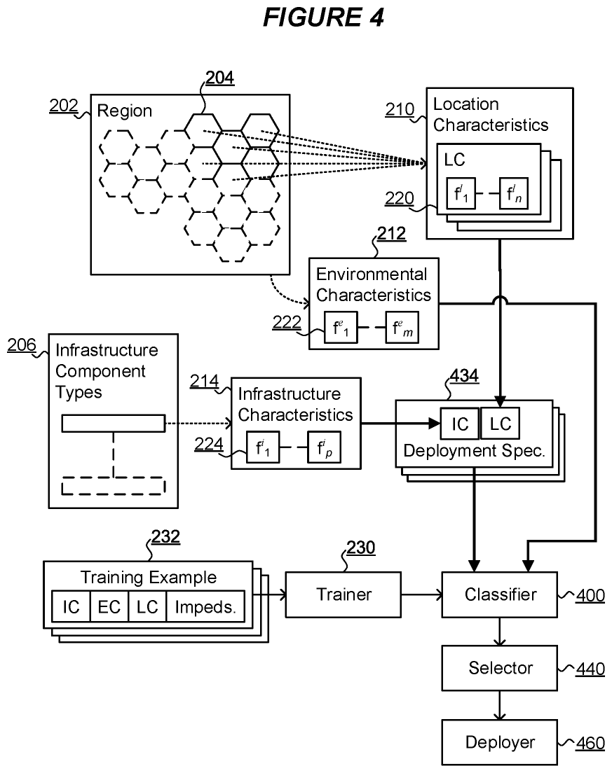

FIG. 4 is a component diagram of an arrangement to define a deployment specification for one or more infrastructure components as part of a transmission network for a utility service in accordance with an embodiment of the present disclosure. Many of the features of FIG. 4 are identical to those described above with respect to FIG. 2 and these will not be repeated here.

The arrangement of FIG. 4 is operable on the basis of a plurality of deployment specifications 434 each corresponding to a deployment option for the deployment of an identified infrastructure component to an identified location in the region 202. Thus, each deployment specification 434 identifies location characteristics (LC) for its identified location and infrastructure characteristics for a component type to which its identified infrastructure component belongs. Accordingly, the deployment options can be selected therebetween based on each deployment specification by classifying each deployment specification, along with the environmental characteristics 212 for the region 202, to forecast a measure of susceptibility of infrastructure that would be deployed in accordance with the deployment specification should the associated deployment option be selected. In this way, a plurality of different deployment options can be selected between by the selector 440 for triggering deployment by the deployer 460 before resource is invested in undertaking any such deployment.

For example, multiple existing infrastructure components may be available for selection therebetween, such as ducts provided at alternative sides of a street, each side constituting a different location in the region 202. Each location (side of the street) has different location characteristics and the ducts may have different infrastructure characteristics. A new deployment, such as the laying/blowing of new fiber optic cables into an existing duct, can be optionally effected at either location. Thus, each side of the street with associated duct infrastructure constitutes a deployment option. The features of location, infrastructure component type and environmental characteristics for each location are processed by the classifier 400 for selection therebetween by the selector 440 to trigger the new deployment on one particular side of the street (one location) by the deployer 460. In this way, measures of susceptibility of each side of the street to operational impediments are determined by the classifier 460 to inform the selection so as to manage, such as by reducing a likelihood of, constrain or avoid, one or more operational impediments for the selected deployment of infrastructure components.

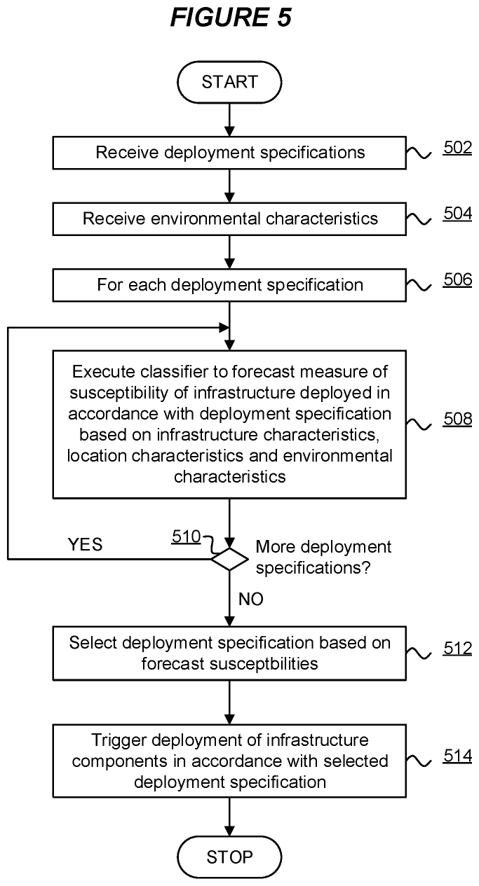

FIG. 5 is a flowchart of a method for defining a deployment specification for one or more infrastructure components as part of a transmission network for a utility service in accordance with an embodiment of the present disclosure. Initially, at 502, the method receives a plurality of deployment specifications 434 each corresponding to a deployment option. At 504 the method receives environmental characteristics associated with the region 202. At 506 the method loops through each of the received deployment specifications. At 508 the classifier 400 is executed to forecast a measure of susceptibility of infrastructure deployed in accordance with the current deployment specification to one or more operational impediments of the infrastructure in use. The classifier is executed based on each of one or more of the infrastructure characteristics, the location characteristics and the environmental characteristics according to the current deployment specification. Subsequently, at 510, the method loops through all deployment specifications. At 512 the method selects a deployment specification based on the forecast susceptibilities. At 514 the method triggers deployment of infrastructure components in accordance with the selected deployment specification.

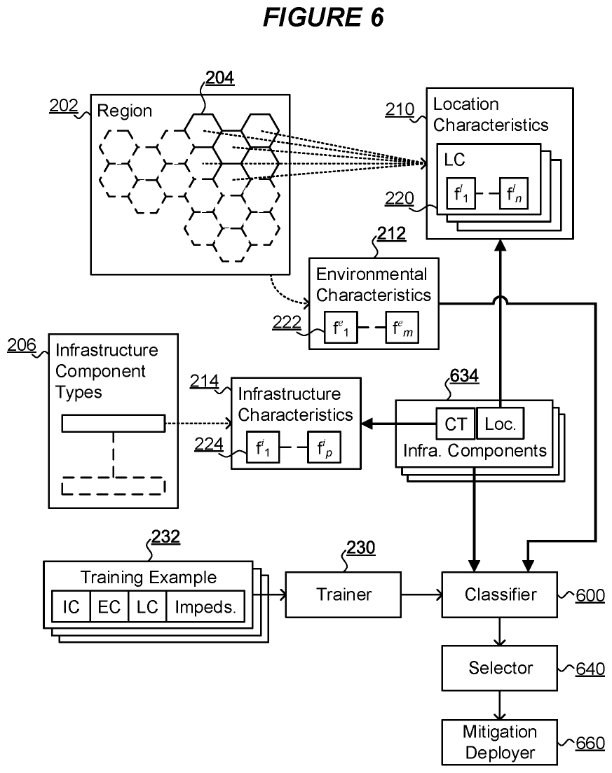

FIG. 6 is a component diagram of an arrangement to define infrastructure components as part of a transmission network for a utility service in accordance with an embodiment of the present disclosure. Many of the features of FIG. 6 are identical to those described above with respect to FIG. 2 and these will not be repeated here.

In the embodiment according to the arrangement of FIG. 6 a plurality of infrastructure components are deployed to locations in the region 202 and the arrangement of FIG. 6 is configured to select and/or prioritize such deployed infrastructure components according to their susceptibility to operational impairments. The purpose of selection and/or prioritization is for the deployment of mitigation measures to mitigate one or more operational impediments to which such selected or prioritized infrastructure components are determined to be susceptible.

Thus, information is provided for deployed infrastructure components 634 including an identification of an infrastructure component type (CT) on which basis infrastructure characteristics 214 for the component 634 can be determined. Further, a location of the infrastructure component (Loc.) is provided on which basis location characteristics 220 can be determined. In use, the infrastructure components 634 can be selected therebetween and/or prioritized by classifying each infrastructure component based on its indicated infrastructure characteristics 214, location characteristics 220 and the environmental characteristics 222 for the region 202. The trained classifier 600 is thus operable to forecast a measure of susceptibility of each deployed infrastructure component 634. In this way, a plurality of infrastructure components 634 can be selected between by the selector 640 for triggering the deployment of mitigations by a mitigation deployer 660.

The mitigation deployer 660 is a software, hardware, firmware or combination component arranged to trigger the deployment of mitigation measures either by automated mitigation means or through the generation of a specification, indication or other suitable means on which basis mitigation measures are otherwise deployed or instantiated. For example, mitigation measures can include: an infrastructure component inspection process; an infrastructure component replacement process; an infrastructure component repair process; a cleaning, desilting and/or unclogging process; and a relocation of the selected infrastructure component. For example, automated mitigation measures can include the activation, deployment or configuration of automated means to achieve, for example, desilting or unclogging of an infrastructure component.

Notably, in some embodiments, the selector 640 is adapted to provide a prioritization of the infrastructure components 634 so that resources expended for the deployment of mitigation measures can be efficiently managed by attending to higher priority infrastructure components first based on the forecast measures of susceptibility to operational impediment determined by the classifier 600.

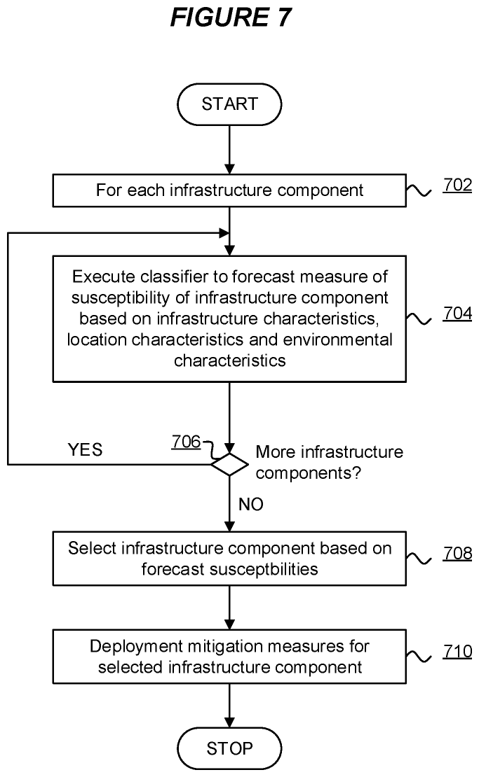

FIG. 7 is a flowchart of a method for maintaining infrastructure components as part of a transmission network for a utility service in accordance with an embodiment of the present disclosure. Initially, at 702, loops through each of the plurality of deployed infrastructure components 634. At 704 the classifier 600 is executed to forecast a measure of susceptibility of each deployed infrastructure component 634 to one or more operational impediments of the infrastructure in use. The classifier 600 is executed based on each of one or more of the infrastructure characteristics, the location characteristics and the environmental characteristics for the current infrastructure component 634. Subsequently, at 706, the method loops through all infrastructure components. At 708 the method selects and/or prioritizes one or more infrastructure components based on the forecast susceptibilities. At 710 the method triggers the deployment of mitigation measures of the selected/prioritized infrastructure components.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of defining a deployment specification for one or more infrastructure components as part of a transmission network for a utility service in a defined geographic region, the method comprising:
receiving a deployment specification for each of a plurality of deployment options, each received deployment specification including a location and a type of one or more infrastructure components for deployment in the region, each type of infrastructure component having associated infrastructure characteristics identifying features of the infrastructure component, and each location having associated location characteristics identifying features of the location;
receiving environmental characteristics for the region identifying environmental features of the region;
for each deployment specification, executing a classifier to forecast a measure of susceptibility of infrastructure deployed in accordance with the specification to one or more operational impediments of the infrastructure in use, the classifier being executed based on one or more of the infrastructure characteristics, the location characteristics, and the environmental characteristics;
selecting a deployment specification based on the forecast measures of susceptibility to trigger deployment of infrastructure components in accordance with the selected deployment specification.

2. The method of claim 1 wherein the classifier is trained based on training data items each relating to one or more deployed infrastructure components for each of which the training data item includes infrastructure characteristics, location characteristics, environmental characteristics, and an indication of one or more operational impediments affecting the deployed infrastructure components.

3. The method of claim 1 wherein the one or more operational impediments are each impediments to the operation of, access to or maintenance of the infrastructure in use.

4. The method of claim 1 wherein an infrastructure component includes one or more of: a duct; a conduit; a pipe; a cable; a pole; a pylon; and a tower.

5. The method of claim 1 wherein each of the one or more operational impediments is one or more of: erosion; corrosion; rotting; movement; damage; being struck; fracture; perforation; blockage; clogging; collapse; silting; and pest damage.

6. The method of claim 1 wherein the features of an infrastructure component include one or more of:
a type of component including one or more of a duct; a conduit; a pipe; a cable; a pole; a pylon; and a tower;
one or more materials of manufacture of the component;
one or more configurations of the component;
a deployment feature of the component; and
one or more physical characteristics of the component including one or more of: mass; density; porosity; permeability; cross-sectional shape; rigidity; strength such as tensile or compressive strength; corrosion resistance; flexibility; brittleness; durability; elasticity;
resilience; and thermal properties.

7. The method of claim 1 wherein the features of a location include one or more of:
a topography of the location including one or more of: elevation; altitude; slope; and incline;
a longitude of the location;
a latitude of the location;
a relative water level or an absolute water table level for the location;
water flow information for the location;
an identification of one or more faults, fissures, shafts and/or voids in the ground at the location;
a type of soil at the location;
an identification of one or more mineral or resource deposits at the location;
a history of the location including one or more of: prior development at the location; and prior uses of the location;
soil salinity;
airborne salinity;
geographic features at or proximate to the location including natural, landform and/or artificial features;
an identification of vegetation at or proximate to the location;
an identification of streams, rivers, seas, oceans or deltas at or proximate to the location;
an identification of hills, mountains and plains at or proximate to the location;
an identification of one or more pre-existing infrastructure components at or proximate to the location including: ducts; conduits; pipes; cables; poles; pylons; and towers; and
an identification of buildings at or proximate to the location.

8. The method of claim 1 wherein the environmental features include one or more of:
climatic features including a statistical measure of one or more of: temperature; humidity; pressure; wind; and precipitation;
weather features including one or more of frequency and severity of one or more of: flooding; storm; excessive wind speed; drought; cold event; snow; and ice.

9. The method of claim 1 wherein selecting a deployment specification based on the forecast measures of susceptibility includes ranking each deployment specification based on one or more metrics derived from the forecasting by the classifier for the deployment specification.

10. The method of claim 9 wherein each of the one or more metrics are evaluated for each deployment specification based on a combination of each forecast measure of susceptibility for each of one or more impediments for the deployment specification.

11. A computer system including a processor and a memory storing computer program code for performing the method of claim 1.

12. A computer program element comprising computer program code to, when loaded into a computer system and executed thereon, cause the computer system to perform the the method of claim 1.
